(19) United States
(12) Patent Application Publication
(10) Pub. No.: US 2013/0267236 A1
(43) Pub. Date: Oct. 10, 2013

(54) SMALLCELL BASE STATION AND CHANNEL ASSIGNMENT METHOD FOR THE SAME

(71) Applicants: YU-TING HUANG, NEW TAIPEI CITY (TW); CHING-FENG HSIEH, TAIPEI CITY (TW)

(72) Inventors: YU-TING HUANG, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/542,021

(22) Filed: Jul. 5, 2012

(30) Foreign Application Priority Data
Apr. 6, 2012 (TW) 101112251

(51) Int. Cl. H04W 72/04

(52) U.S. Cl. 455/450

(57) ABSTRACT

A smallcell base station and a channel assignment method for the same are introduced. In response to a connection mode-related service request make by a user equipment (UE) for performing a communication service, a channel assignment processor of the smallcell base provides a forward access channel (FACH) for functioning as a communication route of the UE, assigns to the UE the FACH for functioning as a wireless transmission channel between the smallcell base and the UE in the connection mode when no dedicated channel (DCH) is available, and discontinues other communication services so as to release a DCH to the UE when the communication service has higher priority. Accordingly, the smallcell base need not keep a DCH for use in accessing during the connection mode, thereby making good use of channel resources.

### CROSS-REFERENCE TO RELATED APPLICATION

This non-provisional application claims priority under 35 U.S.C. §119(a) on Patent Application No(s).101112251 filed in Taiwan, R.O.C. on Apr. 6, 2012, the entire contents of which are hereby incorporated by reference.

### FIELD OF TECHNOLOGY

The present invention relates to base stations and channel assignment methods for the same, and more particularly, to a smallcell base station and a channel assignment method for the same.

### BACKGROUND

A wireless mobile communication network relies upon a large number of base stations in order to expand its signal coverage such that a user equipment (UE) can access various communication services through the base stations.

A mobile communication network can be composed of plenty of small wireless cells, that is, base stations. The coverage, system capacity, and output power vary from base station to base station, depending on the positions or applications of the base stations. In general, the base stations are divided into the some categories according to coverage (or output power), namely macrocell base stations, microcell base stations, picocell base stations, and femtocell base stations. The microcell base stations, picocell base stations, and femtocell base stations are smallcell base stations which are applicable to a densely populated mobile phone use area, such as a railway station or a shopping mall, and are intended to increase network capacity, cover the dead space of macrocell base stations, and speed up data transmission. Therefore, smallcell base stations are usually found in residential areas and small business areas. Referring to FIG. 1, there is shown a schematic view of the layout of a macrocell base station 200, a smallcell base station 100, and a core network 300.

The smallcell base station 100 offers less dedicated channels (DCH) than the macrocell base station 200 does. For example, the smallcell base station 100 usually offers 4, 8, 16, or 32 dedicated channels. Once all the dedicated channels are occupied, calls of higher priority cannot gain access to any dedicated channel offered by the smallcell base station 100. For example, calls of higher priority, such as a 110 phone call or a 119 phone call, cannot gain access to any dedicated channel offered by the smallcell base station 100. Hence, even though all its dedicated channels are occupied, the conventional smallcell base station 100 keeps a dedicated channel for taking care of a priority recognition process requested by the next channel so as to determine whether to discontinue the use of an otherwise operating dedicated channel and give priority to the next channel. In doing so, although the prior art ensures that phone calls of high priority can be received, it results in a waste of a dedicated channel thereby strains the resource-deficient smallcell base station 100.

### SUMMARY

It is an objective of the present invention to overcome a drawback of the prior art, that is, a conventional smallcell base station has to keep a dedicated channel required for priority recognition.

Another objective of the present invention is to operate a smallcell base station in such a manner that all its channel resources are accessible to a user equipment (UE) for providing a communication service.

In order to achieve the above and other objectives, the present invention provides a smallcell base station adapted to provide a wireless transmission channel to a user equipment (UE) within a signal coverage and thereby connect the user equipment to a core network for performing a communication service. The smallcell base station comprises: a radio transceiver serving as a signal transmission medium between the smallcell base station and the user equipment; a network interface enabling the smallcell base station to get connected to the core network via the Internet; and a channel assignment processor having a plurality of forward access channels (FACH) and a plurality of dedicated channels (DCH) connectable to the core network, being electrically connected to the radio transceiver and the network interface, providing communication by means of the forward access channels (FACH) when the user equipment makes a connection mode-related request, and assigning, in response to a determination that a dedicated channel is available, the dedicated channel to the user equipment so as for the dedicated channel to serve as the wireless transmission channel between the smallcell base station and the user equipment in the connection mode.

In an embodiment, the channel assignment processor keeps treating the forward access channel as the wireless transmission channel between the smallcell base station and the user equipment in the connection mode when no said dedicated channel is available.

In an embodiment, the smallcell base station further comprises a storage unit electrically connected to the channel assignment processor. A connection priority list is stored in the storage unit. The channel assignment processor acquires the priority level of the communication service based on the connection priority list when no said dedicated channel is available. The channel assignment processor discontinues the right to access the dedicated channel of another communication service having the lowest priority level and assigns the dedicated channel to the user equipment when the priority level of the communication service is higher than that of at least one of the other communication services occupying the dedicated channels.

In order to achieve the above and other objectives, the present invention further provides a channel assignment method adapted for use with a smallcell base station and adapted for use in channel assignment when a user equipment (UE) registered with the smallcell base station makes a connection mode-related service request for performing a communication service, wherein the smallcell base station provides a wireless transmission channel to the user equipment within a signal coverage and thereby connect the user equipment to a core network for performing a communication service. The channel assignment method comprises the steps of: providing a forward access channel (FACH) for receiving the service request; determining whether a said dedicated channel (DCH) is available; and assigning said dedicated channel (DCH) when the determination is affirmative.

In an embodiment, the channel assignment method further comprises the step of keeping in use the forward access channel (FACH) of the user equipment when all the dedicated channels are occupied.

In an embodiment, after the step of keeping in use the forward access channel (FACH) of the user equipment and when the user equipment needs the dedicated channel for performing the communication service, the channel assignment method further comprises the steps of: acquiring the priority level of the communication service based on a connection priority list; determining whether the priority level of the communication service is higher than that of at least one of the other communication services occupying the dedicated channels; and discontinuing the access to the dedicated channel of the other communication service having the lowest priority and assigning the released dedicated channel to the user equipment if the priority level of the communication service is higher than that of at least one of the other communication services occupying the dedicated channels.

In an embodiment, the channel assignment method further comprises the step of keeping in use the forward access channel (FACH) of the user equipment if the priority level of the communication service is not higher than that of at least one of the other communication services occupying the dedicated channels.

Accordingly, the smallcell base station of the present invention need not keep a dedicated channel but makes good use of the channel resources available to the smallcell base station by allowing a forward access channel to take care of signal transmission of the smallcell base station and the downlink of the user equipment.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a schematic view of the layout of a macrocell base station, a smallcell base station, and a core network;

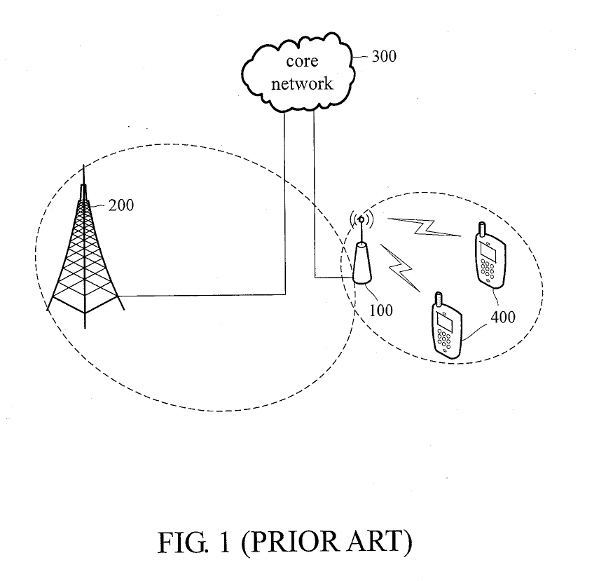

FIG. 2 is a system block diagram of a smallcell base station according to an embodiment of the present invention; and

FIG. 3 is a flow chart of a channel assignment method for use with the smallcell base station according to an embodiment of the present invention.

### DETAILED DESCRIPTION

The present invention relates to assignment, coordination, and management of wireless channels in wireless communication. The techniques and devices described in various embodiments of the present invention are applicable to wireless communication networks, such as a Code-Division Multiple Access (CDMA) network, a Time-Division Multiple Access (TDMA) network, a Frequency-Division Multiple Access (FDMA) network, an Orthogonal FDMA (OFDMA) network, a Single-carrier FDMA (SC-FDMA) network, a Long Term Evolution (LTE) network, and other communication networks.

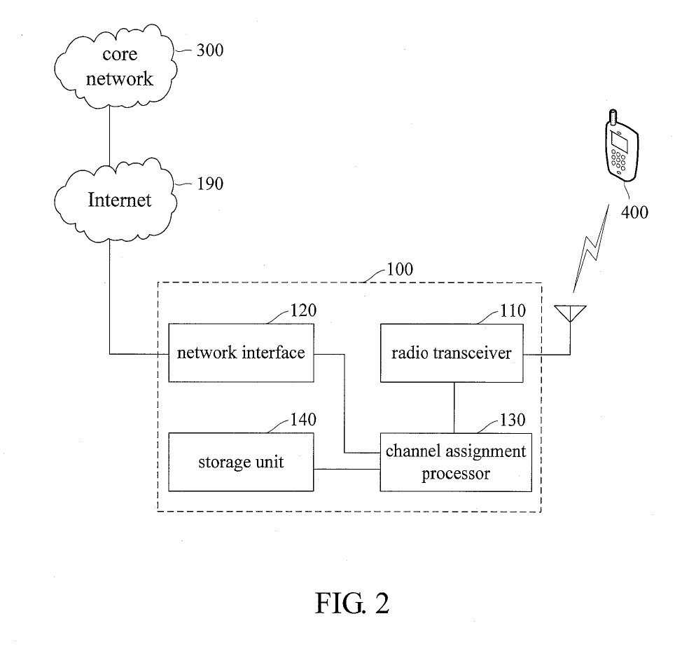

Referring to FIG. 2, there is shown a system block diagram of a smallcell base station 100 according to an embodiment of the present invention. As shown in FIG. 2, the smallcell base station 100 comprises a radio transceiver 110, a network interface 120, and a channel assignment processor 130. Preferably, the smallcell base station 100 further comprises a storage unit 140.

The radio transceiver 110 serves as a signal transmission medium between the smallcell base station 100 and a user equipment (UE) 400 to not only allow the smallcell base station 100 to receive a signal from the user equipment 400 but also allow the smallcell base station 100 to send a signal to the user equipment 400.

The network interface 120 enables the smallcell base station 100 to get connected to the Internet 190 and thereby get connected to the core network 300 via the Internet 190. Hence, for example, the smallcell base station 100 gets connected to the Internet 190 through a family-based or enterprise-oriented network apparatus, and then gets connected to the core network 300, so as to reduce the load of the macrocell base station 200 efficiently, effectuate optimal signal coverage, and enhance wireless service quality.

The channel assignment processor 130 has a plurality of forward access channels (FACH) and a plurality of dedicated channels (DCH) connectable to the core network 300. The channel assignment processor 130 is electrically connected to the radio transceiver 110 and the network interface 120. The channel assignment processor 130 is connected to the user equipment 400 via the radio transceiver 110. The channel assignment processor 130 is connected to the core network 300 via the network interface 120 and the Internet 190 based on a service request from the user equipment 400.

In response to a connection mode-related request made by the user equipment 400, the channel assignment processor 130 enables the user equipment 400 to gain access to the forward access channel (FACH) and thereby get connected to the smallcell base station 100. The channel assignment processor 130 determines whether any dedicated channel is available. After determining that no dedicated channel is available, the channel assignment processor 130 keeps the forward access channel (FACH) in use, thereby offering an alternative to the prior art which teaches keeping a dedicated channel for use with the user equipment 400. The forward access channel (FACH) and the random access channel (RACH) serve as a downlink channel required for the smallcell base station 100 to communicate with the user equipment 400 and an uplink channel required for the user equipment 400 to communicate with the smallcell base station 100, respectively. Hence, the user equipment 400 uses the forward access channel (FACH) to receive a signal from the smallcell base station 100 even though the user equipment 400 is still in a connection mode. After it has been confirmed that the user equipment 400 needs a dedicated channel for performing a specific service, a service request (requesting a dedicated channel) is sent to the smallcell base station 100 by means of the random access channel (RACH). The forward access channel (FACH) and the random access channel (RACH), paired one-way transmission channels, are disclosed in the prior art and thus are not reiterated herein for the sake of brevity.

The storage unit 140 is electrically connected to the channel assignment processor 130. The storage unit 140 stores therein a connection priority list. The channel assignment processor 130 acquires the priority level of the communication service according to the connection priority list when no dedicated channel is available and when the user equipment 400 requires a dedicated channel to be connected to the core network 300 for performing a communication service. If the priority level of the communication service is higher than that of at least one of a plurality of other communication services of the occupied dedicated channels, the channel assignment processor 130 will discontinue the right to access the dedicated channels of the other communication services of the lowest priority level, so as to assign the dedicated channels to the user equipment 400. The command of assigning the dedicated channels is transmitted via the forward access channel (FACH) and intended to allow the user equipment 400 to access various parameters required for the dedicated channels.

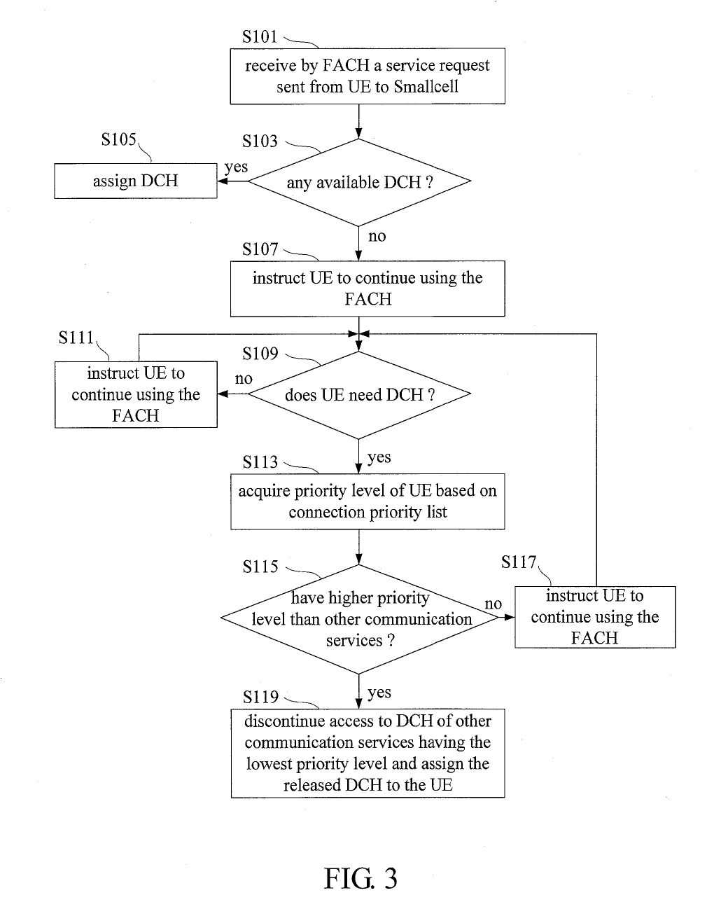

Referring to FIG. 3, there is shown a flow chart of a channel assignment method for use with the smallcell base station according to an embodiment of the present invention. When the user equipment which is registered with the smallcell base station makes a connection mode-related service request, a channel assignment method according to an embodiment of the present invention comprises the following steps.

Step S101: receive a service request from a user equipment (UE), that is, provide a forward access channel (FACH) for receiving a service request sent from the user equipment (UE) to the smallcell base station.

Step S103: determine whether a dedicated channel (DCH) is available.

Step S105: assign a dedicated channel (DCH) when it is determined that a dedicated channel (DCH) is available. Go to step S107, if all the dedicated channels (DCH) are occupied.

Step S107: keep in use the forward access channel (FACH) of the user equipment (UE).

Referring to FIG. 3, the process flow of priority determination after step S107 comprises the following steps.

Step S109: determine whether the user equipment (UE) needs the dedicated channel (DCH) in order to get connected to a core network for performing a communication service.

Step S111: instruct, when it is determined that no dedicated channel (DCH) is required for performing the communication service, the user equipment (UE) to continue using the forward access channel (FACH) and go back to step S109. Go to step S113, if it is determined that a dedicated channel (DCH) is required for performing the communication service.

Step S113: acquire the priority level of the communication service based on a connection priority list.

Step S115: determine whether the priority level of the communication service is higher than that of at least one of the other communication services occupying the dedicated channels (DCH).

Step S117: keep the forward access channel (FACH) in use when it is determined that the priority level of the communication service is not higher than that of at least one of the other communication services occupying the dedicated channels (DCH), and go back to step S109. Go to step S119, if it is determined that the priority level of the communication service is higher than that of at least one of the other communication services occupying the dedicated channels (DCH).

Step S119: discontinue the access to the dedicated channel (DCH) of the other communication service having the lowest priority and assign the released dedicated channel (DCH) to the user equipment. If the communication service has the highest priority level, step S119 will still apply.

In conclusion, the present invention involves assigning and managing channel resources in a manner that, in a connection mode, a forward access channel (FACH) serves as a communication channel connected between the smallcell base station and a user equipment accessing thereto, and assigning a dedicated channel (DCH) to the user equipment only when all the dedicated channels (DCH) are occupied rather than assigning a dedicated channel (DCH) to the user equipment as soon as the user equipment enters the connection mode, thereby making good use of resources available to the smallcell base station by precluding a waste of a dedicated channel reserved according to the prior art.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A smallcell base station adapted to provide a wireless transmission channel to a user equipment (UE) within a signal coverage and thereby connect the user equipment to a core network for performing a communication service, the smallcell base station comprising:
a radio transceiver serving as a signal transmission medium between the smallcell base station and the user equipment;
a network interface enabling the smallcell base station to get connected to the core network via the Internet; and
a channel assignment processor having a plurality of forward access channels (FACH) and a plurality of dedicated channels (DCH) connectable to the core network, being electrically connected to the radio transceiver and the network interface, providing communication by means of the forward access channels (FACH) when the user equipment makes a connection mode-related request, and assigning, in response to a determination that a said dedicated channel is available, the dedicated channel to the user equipment so as for the dedicated channel to serve as the wireless transmission channel between the smallcell base station and the user equipment in the connection mode.

2. The smallcell base station of claim 1, wherein the channel assignment processor keeps treating the forward access channel as the wireless transmission channel between the smallcell base station and the user equipment in the connection mode when no said dedicated channel is available.

3. The smallcell base station of claim 2, further comprising a storage unit electrically connected to the channel assignment processor and stored with a connection priority list, allowing the channel assignment processor to acquire the priority level of the communication service based on the connection priority list when no said dedicated channel is available, and allowing the channel assignment processor to discontinue a right to access the dedicated channel of another communication service having the lowest priority level and assign the dedicated channel to the user equipment when the priority level of the communication service is higher than that of at least one of the other communication services occupying the dedicated channels.

4. A channel assignment method adapted for use with a smallcell base station and adapted for use in channel assignment when a user equipment (UE) registered with the smallcell base station makes a connection mode-related service request for performing a communication service, wherein the smallcell base station provides a wireless transmission channel to the user equipment within a signal coverage and thereby connect the user equipment to a core network for performing a communication service, the channel assignment method comprising the steps of:
providing a forward access channel (FACH) for receiving the service request;
determining whether a said dedicated channel (DCH) is available; and
assigning said dedicated channel (DCH) when the determination is affirmative.

5. The method of claim 4, further comprising the step of keeping in use the forward access channel (FACH) of the user equipment when all the dedicated channels are occupied.

6. The method of claim 5, after the step of keeping in use the forward access channel (FACH) of the user equipment and when the user equipment needs the dedicated channel for performing the communication service, further comprising the steps of:
acquiring the priority level of the communication service based on a connection priority list;
determining whether the priority level of the communication service is higher than that of at least one of the other communication services occupying the dedicated channels; and
discontinuing the access to the dedicated channel of the other communication service having the lowest priority and assigning the released dedicated channel to the user equipment if the priority level of the communication service is higher than that of at least one of the other communication services occupying the dedicated channels.

7. The method of claim 6, further comprising the step of keeping in use the forward access channel (FACH) of the user equipment if the priority level of the communication service is not higher than that of at least one of the other communication services occupying the dedicated channels.
